(19) United States
(12) Patent Application Publication
(10) Pub. No.: US 2016/0160939 A1
(43) Pub. Date: Jun. 9, 2016

(54) RELEASE MECHANISM

(71) Applicant: TOYOTA JIDOSHA KABUSHIKI KAISHA, Toyota-shi, Aichi-ken (JP)

(72) Inventors: Kensei HATA, Susono-shi (JP); Yuji IWASE, Mishima-shi (JP); Yosuke SUZUKI, Susono-shi (JP); Koichi KATO, Nagoya-shi (JP); Seitaro NOBUYASU, Susono-shi (JP); Taro MOTEKI, Susono-shi (JP)

(73) Assignee: TOYOTA JIDOSHA KABUSHIKI KAISHA, Toyota-shi, Aichi-ken (JP)

(21) Appl. No.: 14/908,669

(22) PCT Filed: Aug. 8, 2014
(86) PCT No.: PCT/IB2014/001493

§ 371 Date: Jan. 29, 2016

(30) Foreign Application Priority Data
Aug. 9, 2013 (JP) 2013-165752

(51) Int. Cl. F16D 25/08; F16D 13/58; F16D 13/40

(52) U.S. Cl. CPC F16D 25/087; F16D 25/083; F16D 13/40; F16D 13/583

(57) ABSTRACT

A release mechanism includes a clutch, a bearing, a hydraulic actuator, and a return spring. The clutch transmits a torque between an input-side rotational member and an output-side rotational member by pressing the pressure plate against a clutch disc by an elastic force of a diaphragm spring. The bearing transmits a load in a direction in which a pressure plate is separated from the clutch disc. The bearing is placed on an outer peripheral side of the hydraulic actuator in a radial direction of the output-side rotational member. The hydraulic actuator transmits, to the bearing, a load to separate the pressure plate from the clutch disc. The return spring, the hydraulic actuator, and the bearing are placed so as to overlap with each other in an axis direction of the output-side rotational member. The return spring is placed on an outer peripheral side of the bearing.

### BACKGROUND OF THE INVENTION

1. Field of the Invention

The present invention relates to a release mechanism configured to release a clutch in such a manner that a thrust according to a hydraulic pressure supplied to a hydraulic actuator is applied to a diaphragm spring so that the diaphragm spring decreases a load to press a pressure plate against a clutch disc.

2. Description of Related Art

There has been known a clutch that enables torque transmission between an input-side rotational member and an output-side rotational member by sandwiching a clutch disc connected to the output-side rotational member between a pressure plate connected to an outer peripheral side of a diaphragm spring and the input-side rotational member. A release mechanism configured to release the clutch configured as such is configured to release the clutch by pressing an inner peripheral portion of the diaphragm spring so that the diaphragm spring decreases a load to press the pressure plate against the clutch disc. Further, the release mechanism configured as such is configured to apply, to the diaphragm spring, a thrust according to a hydraulic pressure supplied to a hydraulic actuator. More specifically, a piston in the hydraulic actuator and a bearing abutting with the inner peripheral portion of the diaphragm spring are configured to be movable integrally in an axis direction by a bearing seat. Further, a return spring is provided so as to press the bearing seat toward a bearing-side The release mechanism configured as such is described in Japanese Patent Application Publication No. 07-083247 (JP 07-083247 A) or Japanese Patent Application Publication No. 2002-340028 (JP 2002-340028 A).

A release mechanism described in JP 07-083247 A is provided with a bearing on an outer peripheral side of a rotating shaft so as to be movable in an axis direction, and is configured such that a load based on a hydraulic pressure supplied to a hydraulic actuator is applied to the bearing via a hearing seat. More specifically, the bearing is configured to be pressed by the bearing seat in the same direction as a direction where a piston presses the bearing seat due to the hydraulic pressure supplied to the hydraulic actuator. Further, a return spring is configured to press the bearing seat in the same direction as a direction in which the hydraulic actuator presses the bearing seat. Furthermore, the hydraulic actuator, the bearing, and the return spring are configured to overlap with each other in an axis direction of a rotating shaft. The hydraulic actuator is provided so as to surround an outer peripheral side of the bearing, and the return spring is provided so as to surround an outer peripheral side of the hydraulic actuator. The release mechanism configured as such is configured to separate a pressure plate connected to an outer peripheral side of a diaphragm spring from a clutch disc when the bearing presses an inner peripheral portion of the diaphragm spring according to the hydraulic pressure supplied to the hydraulic actuator.

Further, release mechanisms described in Japanese Patent Application Publication No. 09-112580 (JP 09-112580 A) and Japanese Patent Application Publication No. 2005-201360 (JP 2005-201360 A) are each provided with a hydraulic actuator so as to surround an outer peripheral surface of a rotating shaft. A return bearing is provided so as to press a piston in the same direction as a direction in which the piston is pressed due to a hydraulic pressure supplied to the hydraulic actuator. Further, a bearing seat is connected to a tip portion of the piston, so that a load by which the piston is pressed is transmitted to a bearing via the bearing seat. Further, the hydraulic actuator, the bearing, and the return spring are configured to overlap with each other in an axis direction of the rotating shaft. Further, the return spring is provided so as to surround an outer peripheral side of the hydraulic actuator, and the bearing is provided so as to surround an outer peripheral side of the return spring. The release mechanism is configured to separate a pressure plate connected to an outer peripheral side of a diaphragm spring from a clutch disc when the bearing presses an inner peripheral portion of the diaphragm spring according to the hydraulic pressure supplied to the hydraulic actuator.

Similarly to the release mechanisms described in JP 09-112580 A and JP 2005-201360 A, in a release mechanism described in JP 2002-340028 A, a return spring and a hydraulic actuator are placed, and a bearing is provided in tips of the return spring and the hydraulic actuator. The bearing is configured such that a side surface thereof opposite to another side surface thereof to be pressed by the hydraulic actuator presses a diaphragm spring. Accordingly, when a pressing force according to a hydraulic pressure supplied to the hydraulic actuator is applied to the diaphragm spring, a load is transmitted so that a pressure plate connected to an outer peripheral side of the diaphragm spring is separated from a clutch disc, thereby releasing a clutch.

### SUMMARY OF THE INVENTION

The release mechanism described in JP 07-083247 A or JP 2005-201360 A is configured such that the hydraulic actuator, the return spring, and the bearing are provided so as to overlap with each other in the axis direction of the rotating shaft. This makes it possible to shorten an axial length of the release mechanism. However, when the hydraulic actuator is provided so as to surround an outer periphery of the bearing as described in JP 07-083247 A, a distance to the bearing from a supporting point at which the diaphragm spring is pressed to be flexed becomes longer. This increases a flexure amount of an inner peripheral side of the diaphragm spring. As a result, in order to prevent the diaphragm spring from making contact with a non-movable portion such as a cylinder portion of the hydraulic actuator, it is necessary to secure an additional space for a gap by placing the hydraulic actuator at a position that is away in the axis direction from the supporting point at which the diaphragm spring is pressed to be flexed, for example. This may increase the axial length of the release mechanism.

Further, as described in JP 09-112580 A and JP 2005-201360 A, in a case where the bearing is provided on an outermost peripheral side, a distance between the bearing and the supporting point at which the diaphragm spring is flexed may be shortened. In a case where the distance between the bearing and the supporting point at which the diaphragm spring is flexed is shortened, a ratio of a distance to the pressure plate from the supporting point at which the diaphragm spring is flexed, with respect to a distance to the bearing from the supporting point at which the diaphragm spring is flexed is decreased. This may decrease a load to separate the pressure plate from the clutch disc, relative to a load at which the bearing presses the diaphragm spring. Accordingly, in a case where the release mechanism is configured as such, a hydraulic pressure to he supplied to the hydraulic actuator so as to separate the pressure plate from the clutch disc may be relatively increased, so that a rigidity of the piston, the bearing seat, or the bearing may be increased by just that much. Accordingly, when the rigidity of such members is increased, these members are upsized, which may increase the axial length of the release mechanism.

The present invention provides a release mechanism with a shortened axial length.

A release mechanism. according to one aspect of the present invention includes a clutch, a bearing, a hydraulic actuator, and a return spring. The clutch is configured to transmit a torque between an input-side rotational member rotating integrally with a pressure plate and an output-side rotational member by pressing the pressure plate against a clutch disc connected to the output-side rotational member by an elastic force of a diaphragm spring. The bearing makes contact with the diaphragm spring. The bearing configured to transmit a load in a direction in which the pressure plate is separated from the clutch disc. The hydraulic actuator configured to transmit, to the bearing, a load to separate the pressure plate from the clutch disc. The hydraulic actuator configured to cause the load according to a hydraulic pressure to be supplied to the hydraulic actuator. The bearing disposed on an outer peripheral side of the hydraulic actuator in a radial direction of the output-side rotational member. The return spring configured to apply, to the bearing, a spring force in the same direction as the load. The return spring, the hydraulic actuator, and the bearing disposed so as to overlap with each other in the radial direction of the output-side rotational member. The return spring disposed on an outer peripheral side of the bearing.

In the release mechanism according to the one aspect of the present invention, the hydraulic actuator may include a piston to be pressed in an axial direction of the output-side rotational member according to a load based on the hydraulic pressure to be supplied to the piston, and the hydraulic actuator may include a plate member configured to receive pressing forces in the axial direction from the piston and the return spring and to transmit the pressing forces to the bearing.

In the release mechanism according to the one aspect of the present invention, the pressure plate may be connected to an outer peripheral portion of the diaphragm spring, and the bearing may make contact with an inner peripheral portion of the diaphragm spring.

According to the release mechanism of the one aspect of the present invention, the bearing is placed so as to make contact with the diaphragm spring configured to press the pressure plate against the clutch disc, so that the load in the direction in which the pressure plate is separated from the clutch disc is transmitted from the bearing. Further, the bearing is configured such that a load caused by the hydraulic actuator and a spring force of the return spring are applied to the bearing. Further, the hydraulic actuator, the bearing, and the return spring are placed so as to overlap with each other in the radial direction of the output-side rotational member. This makes it possible to shorten an axial length of the release mechanism configured to separate the pressure plate from the clutch disc. Further, the bearing and the return spring are provided on an outer peripheral side relative to the hydraulic actuator, and the bearing makes contact with the diaphragm spring. This makes it possible to restrain or prevent a non-movable portion such as a cylinder constituting the hydraulic actuator from making contact with a movable portion such as the diaphragm spring or the bearing. As a result, it is not necessary to form an additional space by providing a gap to prevent the non-movable portion from making contact with the movable portion, thereby making it possible to shorten the axial length of the release mechanism.

Further, the bearing is placed on the outer peripheral side of the hydraulic actuator in the radial direction of the output-side rotational member, and the return spring is placed on the outer peripheral side of the bearing. This makes it possible to increase an outside diameter of the bearing, thereby making it possible to decrease a contact pressure applied to the bearing. This consequently makes it possible to improve durability of the bearing. Further, it is also possible to increase an outside diameter of the return spring, thereby consequently making it possible to decrease the number of active turns of the return spring. As a result, it is possible to shorten an axial length thereof at the time when the return spring is compressed, thereby eventually making it possible to shorten the axial length of the release mechanism.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view to describe an exemplary configuration of a release mechanism according to the present invention; and

FIG. 2 is a schematic view illustrating an example of a gear train of a vehicle including a clutch controlled to be engaged and released by the release mechanism according to the present invention.

### DETAILED DESCRIPTION OF EMBODIMENTS

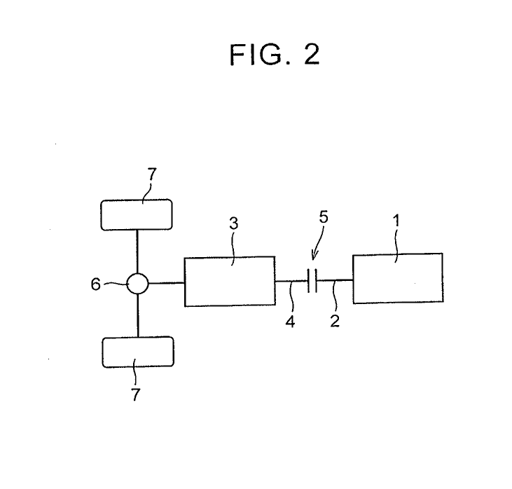

A clutch of the present invention is configured such that, when a pressure plate configured to rotate integrally with an input-side rotational member is pressed by a clutch disc connected to an output-side rotational member, the input-side rotational member is connected to the output-side rotational member in a torque transmittable manner. The clutch configured as such is configured to be released in such a manner that a load to separate the pressure plate from a clutch disc is applied to the clutch to decrease a frictional force. FIG. 2 schematically illustrates an example of a gear train of a vehicle including the clutch configured as such. The gear train illustrated in FIG. 2 is provided in a vehicle front side, and is mounted in a front-engine front-drive vehicle configured such that a torque is transmitted to front wheels. Further, the vehicle illustrated in FIG. 2 is configured such that a clutch 5 is provided between a crankshaft 2 serving as an output shaft of an engine 1 and an input shaft 4 of a transmission (T/M) 3, and a torque is transmittable between the engine 1 and the transmission 3 by engaging the clutch 5. Driving wheels 7, 7 are connected to an output side of the transmission 3 via a differential gear 6. The gear train configured as such is required to shorten a length thereof in a vehicle width direction. In view of this, it is preferable to shorten an axial length of the clutch 5 or an axial length of a release mechanism configured to control engagement and release of the clutch 5.

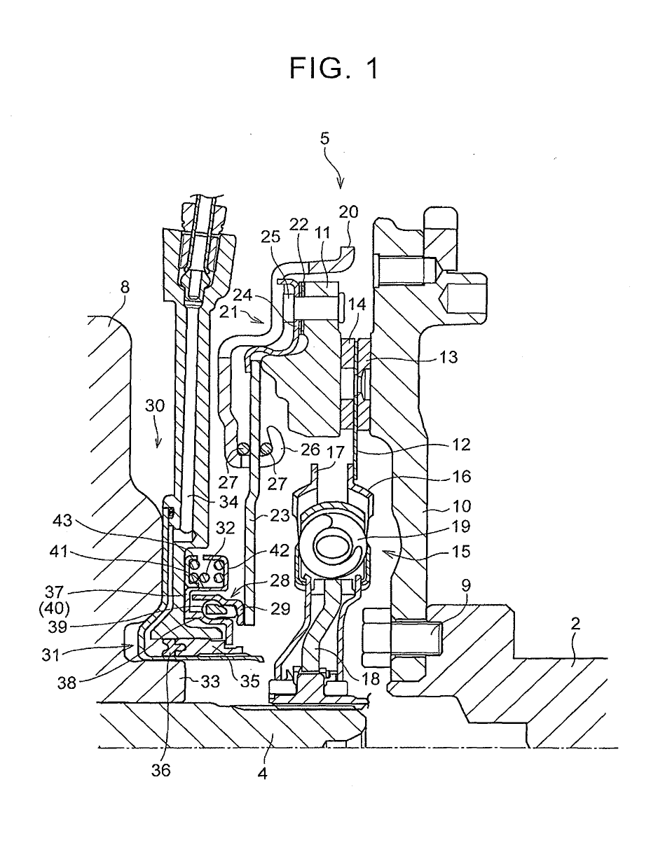

For this purpose, the present invention is configured such that the axial length of the release mechanism functioning to release the clutch 5 is shortened. FIG. 1 is a sectional view to describe an exemplary configuration of the clutch 5 and the release mechanism. The clutch 5 illustrated in FIG. 1 is provided between the engine 1 and the transmission 3. More specifically, the clutch 5 is provided closer to the engine 1 than a housing 8 surrounding the transmission 3. Accordingly, the clutch 5 illustrated in FIG. 1 is a dry clutch configured to transmit a torque without providing oil to an engagement face with which the clutch 5 is engaged. Here, a configuration of the clutch 5 illustrated in FIG. 1 is described first in detail. The clutch 5 illustrated in FIG. 1 is configured to connect or disconnect the crankshaft 2 to or from the input shaft 4 of the transmission 3. More specifically, the clutch 5 includes a flywheel 10 integrated with the crankshaft 2 by a bolt 9. Note that the input shaft 4 corresponds to an output-side rotational member in the present invention, and the crankshaft 2 corresponds to an input-side rotational member in the present invention.

Further, a pressure plate 11 formed in an annular shape is placed so as to be opposed to that side surface of the flywheel 10 which faces the transmission 3. A clutch disc 12 formed in an annular shape is provided so as to be sandwiched between the pressure plate 11 and the flywheel 10. Note that a first friction material 13 formed in an annular shape is formed integrally on that side surface of the clutch disc 12 which is opposed to the flywheel 10, and a second friction material 14 formed in an annular shape is formed integrally on that side surface of the clutch disc 12 which is opposed to the pressure plate 11. The clutch disc 12 is configured so as to be able to transmit a torque to the input shaft 4 via a torsional damper 15. The torsional damper 15 is provided so as to damp a variation of a torque output from the engine 1, and can be configured in the same manner as a conventionally known torsional damper.

A configuration of the torsional damper 15 is described below in brief. That is, the torsional damper 15 is provided with a first input side plate 16 formed integrally with the clutch disc 12, and a second input side plate 17 integrated with the first input side plate 16 by a rivet (not shown) and provided so as to be distanced from the first input side plate 16 via a predetermined gap. Further, the torsional damper 15 is provided with an output side plate 18 so as to be sandwiched between the first input side plate 16 and the second input side plate 17. The output side plate 18 is provided so as to be rotatable rotate relative to each of the input side plates 16, 17. A spring 19 radially expanding and contracting is provided between the input side plates 16, 17 and the output side plate 18. Accordingly, a torque is transmitted from each of the input side plates 16, 17 to the output side plate 18 via the spring 19. In view of this, in a case where an output torque of the engine 1 varies, the spring 19 functions to damp the variation of the torque and to transmit the torque to the output side plate 18. Note that the output side plate 18 is engaged with the input shaft 4 by splines or the like. That is, the output side plate 18 is provided so as to be movable in an axis direction of the input shaft 4 and to rotate integrally with the input shaft 4.

As described above, when the clutch disc 12 is provided between the pressure plate 11 and the flywheel 10 so as to increase a clamping pressure to sandwich the clutch disc 12, that is, when respective frictional forces between the flywheel 10 and the friction material 13 and between the pressure plate 11 and the friction material 14 are increased, the crankshaft 2 is connected to the input shaft 4 in a torque transmittable manner. In contrast, when the clamping pressure to sandwich the clutch disc 12 is decreased, that is, when the respective frictional forces between the flywheel 10 and the friction material 13 and between the pressure plate 11 and the friction material 14 are decreased, torque transmission between the crankshaft 2 and the input shaft 4 is blocked.

Further, the pressure plate 11 is surrounded by a clutch cover 20 connected to the flywheel 10 by a bolt or the like (not shown). More specifically, the clutch cover 20 is formed so as to surround an outer peripheral side of the pressure plate 11 and a transmission side thereof in the axis direction. Further, the clutch cover 20 has a plurality of through holes 21 formed toward the axis direction at predetermined intervals in a circumferential direction. A strap plate 22 connecting the clutch cover 20 to the pressure plate 11 and a hold member 24 holding the after-mentioned diaphragm spring 23 are connected to the pressure plate 11 by rivets 25 in the same places where the through holes 21 are formed in a radial direction of the pressure plate 11. The strap plate 22 is a plate member having a predetermined length in a circumferential direction. One end of the strap plate 22 is connected to that side surface of the pressure plate 11 which faces the transmission 3, and the other end thereof is connected to that inner wall surface of the clutch cover 20 which is opposed to the pressure plate 11. The strap plate 22 is configured to apply a load in a direction in which the pressure plate 11 is separated from the clutch disc 12.

Further, the example illustrated in FIG. 1, an outer peripheral portion of the diaphragm spring 23 is sandwiched between an inner peripheral portion of the hold member 24 and the pressure plate 11. In other words, the outer peripheral portion of the diaphragm spring 23 and the pressure plate 11 are integrally movable in the axis direction.

Further, a hook portion 26 formed to be bent toward the engine 1 in the axis direction so that a tip of the bending part of the hook portion 26 is further bent radially is provided on an inner peripheral portion of the clutch cover 20. The hook portion 26 is provided so that a pivot ring 27 formed from a steel material and having a circular section is hooked over the hook portion 26 in a winding manner or so that the pivot ring 27 is positioned in the axis direction. A plurality of hook portions 26 is formed at predetermined intervals in the circumferential direction. Two pivot rings 27, 27 formed in an annular shape are hooked over the hook portions 26 in a winding manner via a predetermined gap in the axis direction. Further, between the hook portions 26, 26, the diaphragm spring 23 formed in an annular shape is provided so as to be sandwiched between the pivot rings 27, 27. The diaphragm spring 23 is configured in a similar manner to a conventionally known diaphragm spring, and includes an outer edge formed in an annular shape, and a coned disc spring portion formed on an inner peripheral side via a predetermined gap therefrom in a radial direction. Further, an inner peripheral portion of the diaphragm spring 23 makes contact with an outer race 29 of the after-mentioned bearing 28.

Next will be described a configuration of the release mechanism 30 configured to apply a load to release the clutch 5. The release mechanism 30 illustrated in FIG. 1 is constituted by a hydraulic actuator 31, a return spring 32, and a bearing 28. The hydraulic actuator 31 is provided along an outer peripheral surface of a projection 33 projecting in the axis direction from the housing 8 fitted to the input shaft 4. Further, the hydraulic actuator 31 is configured such that oil is supplied thereto from a hydraulic power source (not illustrated) via an oil passage 34 to a transmission-3 side in the axis direction. Further, due to a hydraulic pressure of the oil supplied from the hydraulic power source, a piston 35 moves toward the flywheel 10 in the axis direction. Note that in the example illustrated in FIG. 1, a sealing member 36 configured to restrain oil leakage is provided integrally with that end of the piston 35 which is placed on the transmission-3 side in the axis direction, and the oil passage 34 is connected so as to supply the oil from the hydraulic power source to an area closer to the transmission-3 side than the sealing member 36.

Further, the bearing 28 is provided so as to surround an outer peripheral side of the hydraulic actuator 31, and further, the return spring 32 is provided so as to surround an outer peripheral side of the bearing 28. Further, the hydraulic actuator 31, the bearing 28, and the return spring 32 are provided so as to overlap with each other in the radial direction of the input shaft 4.

The bearing 28 is configured to apply an axial load to the diaphragm spring 23. More specifically, the bearing 28 is configured to apply, to the diaphragm spring 23, a load based on the hydraulic pressure supplied to the hydraulic actuator 31. In the example illustrated in FIG. 1, an annular plate member 37 is fitted to an outer peripheral surface of the piston 35, so that the piston 35 is integrated with the plate member 37. Further, the plate member 37 includes a cylindrical portion 38 that is bent toward the transmission 3 in the axis direction so as to be placed along with an outer peripheral surface of the hydraulic actuator 31. Further, part of an outer peripheral surface of the cylindrical portion 38 makes contact with rollers 39 of the bearing 28. That is, the cylindrical portion 38 is formed so as to function as an inner race. Further, an outer race 29 formed in an annular shape is provided so as to cover outer peripheral sides of the rollers 39 and side surfaces thereof on an engine-1 side in the axis direction. The outer race 29 is configured to make contact with the diaphragm spring 23.

Further, an end of the cylindrical portion 38, more specifically, a transmission-3-side end of the cylindrical portion 38 includes a first flat plate portion 40 that is bent radially. The first flat plate portion 40 is formed larger than an outside diameter of the outer race 29. An outer peripheral end of the first flat plate portion 40 is bent toward the engine 1, and an end of a cylindrical portion 41 thus bent toward the engine 1 is further bent outwardly. A second flat plate portion 42 thus bent outwardly is formed as a pressure receiving portion configured to receive a spring force of the return spring 32. More specifically, the second flat plate portion 42 receives a load from the return spring 32 so as to press the rollers 39 of the bearing 28 and the plate member 37 all the time.

Note that, in the example illustrated in FIG. 1, a washer 43 configured to receive a reaction force of the return spring 32 is provided on the transmission-3 side in the axis direction. Further, an outer peripheral portion of the second flat plate portion 42 is bent toward the transmission 3 in the axis direction, so as to restrain or prevent the return spring 32 from being detached. Further, both ends of the return spring 32 are configured to be wound further around their respective outer peripheral sides (i.e., both ends of the return spring 32 are wound doubly around).

When the hydraulic actuator 31 and the bearing 28 are configured as described above, a load based on the hydraulic pressure supplied to the hydraulic actuator 31 is applied to the bearing 28. The outer race 29 of the bearing 28 is placed so as to make contact with an inner peripheral portion of the diaphragm spring 23 formed in an annular shape. Accordingly, the load applied to the bearing 28 is applied to the inner peripheral portion of the diaphragm spring 23, so as to flex the diaphragm spring 23.

The following describes functions of the clutch 5 and the release mechanism 30 configured as described above. In the example illustrated in FIG. 1, when a hydraulic pressure is not supplied to the hydraulic actuator 31, the clutch 5 is engaged. More specifically, since the hydraulic pressure is not supplied to the hydraulic actuator 31, the bearing 28 moves closest to the transmission-3 side. Accordingly, the inner peripheral portion of the diaphragm spring 23 moves toward the transmission 3. When the inner peripheral portion of the diaphragm spring 23 moves closest to the transmission-3 side as such, a load at which the pressure plate II is pressed by the outer peripheral portion of the diaphragm spring 23 becomes larger than an elastic force of the strap plate 22, and further, respective frictional forces between the flywheel 10 and the friction material 13 and between the pressure plate 11 and the friction material 14 reach values according to a maximum value of a torque capacity requested to the clutch 5. That is, a spring force of the diaphragm spring 23, a ratio between a distance from the inner peripheral portion of the diaphragm spring 23 to the pivot rings 27, 27 and a distance from the outer peripheral portion of the diaphragm spring 23 to the pivot rings 27, 27, a rigidity of the strap plate 22, and the like are determined so as to satisfy the torque capacity requested to the clutch 5 at the time when the hydraulic pressure is not supplied to the hydraulic actuator 31 as such.

When the clutch 5 is released or the torque capacity of the clutch 5 is decreased, a hydraulic pressure is supplied to the hydraulic actuator 31 according to a torque capacity requested to the clutch 5. When the hydraulic pressure is supplied to the hydraulic actuator 31 as such, the piston 35 is pressed toward the engine-1 side in the axis direction, and a pressing force thereof is applied to the inner peripheral portion of the diaphragm spring 23 via the plate member 37 and the bearing 28. When the inner peripheral portion of the diaphragm spring 23 is pressed toward the engine-1 side, a load is applied in a direction in which the pressure plate 11 is separated from the clutch disc 12, according to a pressing force thereof, a rate of spring of the diaphragm spring 23, and the ratio between the distance from the inner peripheral portion of the diaphragm spring 23 to the pivot rings 27, 27 and the distance from the outer peripheral portion of the diaphragm spring 23 to the pivot rings 27, 27. As a result, the respective frictional forces between the flywheel 10 and the friction material 13 and between the pressure plate 11 and the friction material 14 are decreased, or the pressure plate 11 and the flywheel 10 are separated from the clutch disc 12. Accordingly, the clutch 5 is released or the torque capacity of the clutch 5 is decreased.

When the hydraulic actuator 31, the bearing 28, and the return spring 32 are provided so as to overlap with each other in the radial direction as described above, it is possible to shorten the axial length of the release mechanism 30 configured to release the clutch 5. Further, when an outside diameter of the bearing 28 becomes large, a contact area between the diaphragm spring 23 and the bearing 28, more specifically, a contact area between the diaphragm spring 23 and the outer race 29 is increased, thereby making it possible to decrease a contact pressure applied to those members 23, 29. As a result, it is possible to improve durability of the bearing 28 and the diaphragm spring 23. Further, the bearing 28 and the return spring 32 are provided on an outer side relative to the hydraulic actuator 31, and the bearing 28 makes contact with the diaphragm spring 23. This also makes it possible to restrain or prevent a non-movable portion such as a cylinder constituting the hydraulic actuator 31 from making contact with a movable portion such as the diaphragm spring 23 or the bearing 28. In other words, the non-movable portion is not placed on a locus of the movable portion. As a result, it is not necessary to form an additional space by providing a gap to prevent the non-movable portion from making contact with the movable portion, thereby making it possible to shorten the axial length of the release mechanism 30.

Further, it is possible to increase an outside diameter of the return spring 32, thereby consequently making it possible to decrease the -number of active turns of a winding constituting the return spring 32. This hardly causes wire adhesion of the return spring 32, that is, it is possible to shorten an axial length thereof at the time when the return spring 32 is compressed, thereby making it possible to shorten the axial length of the release mechanism 30.

Further, the bearing 28 is provided on an inner side relative to the return spring 32, thereby making it possible to restrain or prevent a distance between the hearing 28 and the pivot rings 27, 27 from being shortened excessively. As a result, it is possible to restrain or prevent the spring force of the diaphragm spring 23 from being decreased to decrease a load to separate the pressure plate 11 from the clutch disc 12. In other words, it is possible to increase a thrust caused by the hydraulic actuator 31 so as not to decrease the load to separate the pressure plate 11 from the clutch disc 12, and more specifically, it is possible to restrain or prevent the hydraulic actuator 31 from being upsized.

Note that the above description deals with an example in which the clutch is provided between the engine and the transmission, but a place in which to provide the clutch is not limited particularly in the present invention. Accordingly, a motor generator may be provided in the transmission illustrated in FIG. 2, and the clutch may be provided in a power transmission path between an output shaft of the motor generator and a driving wheel. Further, the present invention may be targeted for a clutch provided in an electric vehicle using only a motor generator as a driving force source, a hybrid vehicle using an engine and a motor generator as a driving force source, or the like vehicle.

1. A release mechanism comprising:
a clutch configured to transmit a torque between an input-side rotational member and an output-side rotational member by pressing a pressure plate against a clutch disc by an elastic force of a diaphragm spring, the input-side rotational member being configured to rotate integrally with the pressure plate, the clutch disc being connected to the output-side rotational member;
a bearing that makes contact with the diaphragm spring, the bearing configured to transmit a load in a direction in which the pressure plate is separated from the clutch disc;
a hydraulic actuator configured to transmit, to the bearing, the load to separate the pressure plate from the clutch disc, the hydraulic actuator configured to cause the load according to a hydraulic pressure to be supplied to the hydraulic actuator, and the bearing disposed on an outer peripheral side of the hydraulic actuator in a radial direction of the output-side rotational member; and
a return spring configured to apply, to the bearing, a spring force in the same direction as the load,
the return spring, the hydraulic actuator, and the bearing disposed so as to overlap with each other in the radial direction of the output-side rotational member, and
the return spring disposed on an outer peripheral side of the bearing.

2. The release mechanism according to claim 1, wherein:
the hydraulic actuator includes a piston to be pressed in an axial direction of the output-side rotational member according to a load based on the hydraulic pressure to be supplied to the piston, and
the hydraulic actuator includes a plate member configured to receive pressing force in the axial direction from the piston and the return spring, and the plate member is configured to transmit the pressing force to the bearing.

3. The release mechanism according to claim 1, wherein:
the pressure plate is connected to an outer peripheral portion of the diaphragm spring, and
the bearing makes contact with an inner peripheral portion of the diaphragm spring.
